(19) United States
(12) Patent Application Publication
(10) Pub. No.: US 2002/0069110 A1
(43) Pub. Date: Jun. 6, 2002

(54) Internet web site

(76) Inventor: David Sonnenberg, Tenafly, NJ (US)

Correspondence Address: DORSEY & WHITNEY, LLP, SUITE 4700, 370 SEVENTEENTH STREET, DENVER, CO, 80202-5647, US

(21) Appl. No.: 09/996,124

(22) Filed: Nov. 27, 2001

Related U.S. Application Data
(60) Provisional application No. 60/253,174, filed on Nov. 27, 2000.

(51) Int. Cl. G06F 17/60

(52) U.S. Cl. 705/14; 705/26

(57) ABSTRACT

The present invention provides of method of conducting an e-commerce business which enables customers to purchase products directly from suppliers via an internet web site. The Internet web site contains a database of information about the products including: price, composition, color, design and the supply of each product. Further, the web site includes pricing information related to the products including the manufacturer's price, the supplier's price (if different than the manufacturer), and the customer's price. Discounts, promotions and other price related information may also be available via the web site.

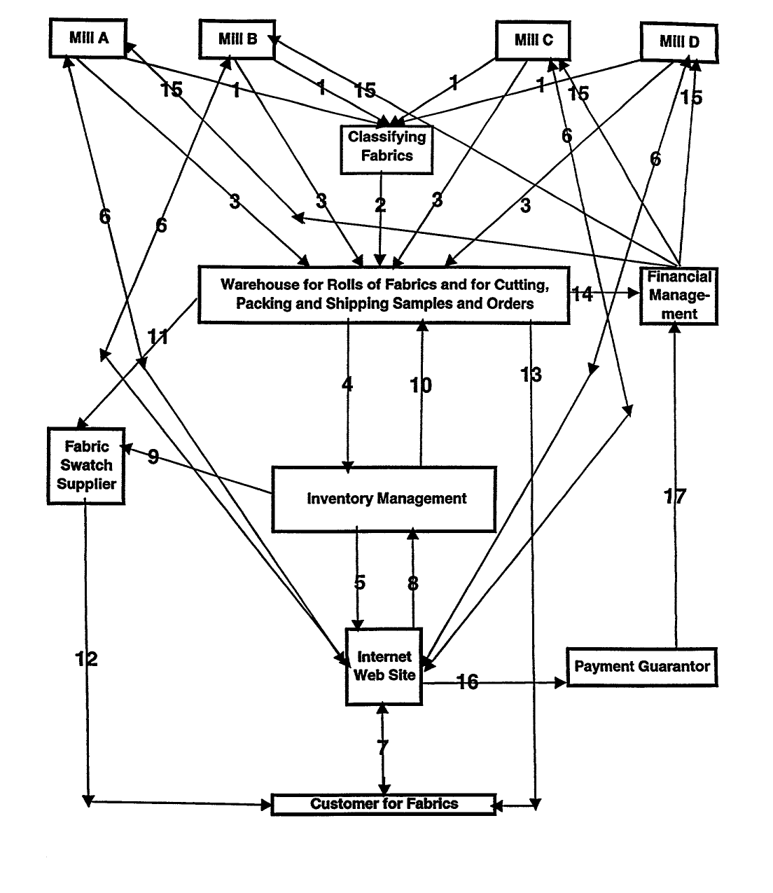

### CROSS REFERENCE TO RELATED APPLICATIONS

The present application claims priority to U.S. Provisional Patent Application Serial No. 60/253,174, entitled “Internet Web Site”, filed on Nov. 27, 2000, in the name of the inventor David Sonnenberg, the contents of which are hereby incorporated by reference in their entirety.

### FIELD OF THE INVENTION

This invention relates to a method of doing an e-commerce business, especially a business-to-business e-commerce business. This invention particularly relates to a method of doing business which enables professional buyers and dealers to purchase interior products, such as soft goods and furnishings, including fabrics, and furniture, directly from affiliated companies and third party suppliers through an internet web site containing information about such products. This invention quite particularly relates to a method of doing business, centered around an internet web site that is provided with a data base of fabrics and a search engine, enabling buyers to identify and purchase fabrics over the internet.

### BACKGROUND OF THE INVENTION

In recent years, the worldwide internet has made it easy and popular for individuals and businesses to exchange reliably and quickly electronic information directly with each other. This has made it possible, for example, for customers to see photographs and data for a wide variety of products on the web sites of the products' manufacturers, wholesalers and/or distributors. This has allowed the customers then to select certain of these products and request, via the web site, additional information and/or samples of these products directly from the manufacturers, wholesalers and/or distributors and to purchase these products directly from them.

### SUMMARY OF THE INVENTION

This invention provides a method of carrying out an e-commerce business which enables customers to purchase products, such as fabrics, directly from their suppliers, such as their manufacturers, through an internet web site containing information about the products. The method comprises the step of:

establishing a database with data entries for each of the products, consigned by its supplier to the business; the database comprising data for the price, composition, color, design and supply of each product; and data of the database being accessible to the customers, suppliers and the business via the web site.

In accordance with another aspect of the invention, the method comprises the steps of:

establishing a database with data entries for each of the products, consigned by its supplier to the business; and

establishing a customers site on the web site that is accessible to the customers and a suppliers site on the web site that is accessible to the suppliers;

wherein data of the database that are accessible to the customers on the customers site are different from data of the database that are accessible to the suppliers on the suppliers site.

Advantageously, the data of the database for the price of each product include both the price to the business, set by the product's supplier, and the price to consumers, set by the business. Also advantageously, each supplier can change, in the database, the supplier's own set price for each of the supplier's products, which results automatically in an eventual change in the business' set price to consumers for the product. Further advantageously, each supplier's set price for each of the supplier's products is accessible to the supplier on the suppliers site but is not accessible to customers on the customers site.

Further aspects of the invention will be apparent from the detailed description below of a particular embodiment and the drawing thereof in the attached FIGURE.

### BRIEF DESCRIPTION OF THE DRAWING FIGURE

The FIGURE shows schematically the flow of information and fabrics relative to an internet web site, via lines of communication 1-15, in accordance with this invention.

### DETAILED DESCRIPTION OF THE INVENTION

As seen from the attached FIGURE, the e-commerce business (hereinafter the “Business”) of this invention involves one or more, Mills (e.g., Mill A, Mill B, Mill C and Mill D) who have agreed to consign rolls of certain fabrics (e.g., woven fabrics, knit fabrics and non-woven fabrics), which the Mills produced, to an Owner or Operator (hereinafter the “Operator”) of the Business. In this regard, each agreement between a Mill and the Operator specifies: the Mill's specific fabrics that are to be consigned to the Operator, the Mill's identification number and the corresponding identification number of the Business for each fabric; the specific quantity, i.e., number of rolls, of each fabric to be consigned, including the length and width of the fabric on each roll; the conditions under which such fabrics are to be consigned; and the conditions under which the Business will offer to sell the specific fabrics via the Business' internet web site. Pursuant to each such consignment agreement with a Mill, the Business provides the Mill with a supplier password which it can use to access a supplier site on the Business' internet web site in a conventional manner.

As a result of their agreements with the Operator, the Mills initially send, via line of communication 1, samples of their specific fabrics—including the Mills' identification number and, if possible, the Business' identification number for each fabric—to the Business' facility for classifying fabrics. Preferably, each Mill also sends 1, to the Business' facility for classifying fabrics, the composition of each of its fabrics that was sent, classified according to the following four variables: application, fabric name, base material and design application. A preferred list of the items which make up each of the four variables of the classification of the composition of fabrics is attached as EXHIBIT A. At the Business' facility for classifying fabrics, the samples of each Mill's fabrics are classified by color, preferably according to a well-recognized conventional color-coding system such as the Pantone® system, and design, as well as by composition if the Mill has not so-classified its fabric or simply to verify the Mill's classification of composition. The design of each fabric is classified according to the descriptors of era, geographic origin and theme and according to the dimensions of pattern type, secondary color contrast, pattern size, styling, repeat scale and simplicity. A preferred list of the items which make up each of the descriptors and dimensions of the design of fabrics is attached as EXHIBIT B. In addition, the Business' facility for classifying fabrics photographs the samples, so that they can subsequently be displayed and viewed on the Business' internet web site. The Business' facility for classifying fabrics then enters, via line of communication 2, the resulting data and photographs in the data base of the Business inventory management.

Thereafter, the Mills ship, via line of communication 3, their rolls of fabrics, as agreed, to a Warehouse of the Business. The Warehouse enters, via line of communication 4, the data concerning the supply of each fabric, received from a Mill, in the data base of the Business' inventory management. In this regard, each shipment from each Mill identifies the fabrics being shipped, the number of rolls and the length and width of the fabric on each roll, together with the Mill's identification numbers and if possible, the Business' corresponding identification numbers for the fabrics.

The Warehouse also stores each roll of fabric received from each Mill, so that it can readily be retrieved, cut, packed and shipped, when necessary. In this regard, the Warehouse is adapted, inter alia, to cut, pack and ship lengths of fabric from each Mill's rolls of fabrics to: i) Customers who have placed orders on the customer site of the Business' internet web site and ii) a fabric swatch supplier who can thereafter cut, pack and ship swatches (i.e., sample quantities) of the fabrics requested by potential Customers on the customer site of the Business' internet web site. Preferably, the Warehouse is adapted to send fabrics to Customers on at least one entire continent (e.g., North America and/or South America) which may be different from the continent (e.g., Europe) where the Mills are located.

When the supply data 4, for each roll of consigned fabric from each Mill, and the fabric classification data and a photograph 2, 4, for that roll of consigned fabric of that Mill, have been entered in the Business' data base, the Business' inventory management posts, via line of communication 5, this data and photograph on the supplier site of the Business' internet web site. There, using its own supplier password, each Mill can access, via line of communication 6, the data and photograph for each of its own fabrics.

The Business then informs (e.g., by e-mail) each Mill that: i) it can review 6 this data and photograph for each of its fabrics on the supplier site of the Business' internet web site, to verify that the data and photograph are accurate, and ii) it can also enter 6, on the supplier site, its supplier price for each fabric, as well as any applicable discounts (e.g., quantity, promotional and/or discretionary discounts) from its supplier price. These steps can be carried out in a conventional manner via the internet.

After the Mill has: i) verified that the posted supply data 4 and fabric classification data and photograph 2, 4 are accurate on the supplier site of the Business' internet web site for each of its fabrics and ii) entered 6 its supplier price and any discounts for each fabric on the supplier site, the Mill can then so inform 6 the Business' inventory management, via the supplier site. After a Mill transmits 6 this information to the inventory management, the inventory management posts 5 automatically such data and photograph and the Business' list price for each fabric on the customer site of the Business' internet web site. The posted list price for each fabric will include:

a. the Mill's supplier price for the fabric which it entered 6 on the supplier site;

b. the Business' profit margin on each sale of the fabric;

c. the Business' costs including: i) warehousing the fabric, ii) classifying the fabric, iii) posting the fabric's data and photograph on the internet web site, iv) cutting, packing and shipping the fabric to each Customer, v) cutting, packing and shipping small pieces of the fabric to the fabric swatch supplier, vi) the swatch supplier's services and vii) costs of insurance, marketing, advertising, credit card charges, currency fluctuations, import duties, sales taxes, scrap, and the like; and

d. any quantity, promotional and/or discretionary discounts of the Mill from its supplier price and/or any Customer, promotional and/or discretionary discounts of the Business.

In accordance with this invention, each Mill can always access, using its own supplier password, the supplier site of the Business' internet web site. There, the Mill can see, for each of its consigned fabrics:

1. its supplier price, as well as the corresponding list price, for the fabric for each of the Mill's geographical markets and, if desired, for each of the Mill's market segments;

2. the Mill's quantity, promotional and discretionary discounts for the fabric;

3. the sales of the fabric for each of the Mill's geographical markets and, if desired, for each of the Mill's market segments;

4. the supply of the fabric in each of the Business' Warehouses and whether the Mill should resupply the Warehouse with the fabric;

5. the sales yield for each roll of consigned fabric, taking into account flaws in the fabric, scrap from cutting it, small pieces cut from it for swatches, and its actual sales; this allows the Mill to adjust its supplier price to assure a profit based on the yield of fabric actually sold from each roll; this also allows the Mill to learn rapidly of the amount of imperfections in each of the Mill's consigned fabric from seeing the yield from initial sales of the fabric, thereby allowing the Mill to control and possibly improve the quality of subsequent rolls of the fabric which the Mill will produce; and

6. sales trends of all fabrics of all Mills, posted on the Business' web site.

However, each Mill can only access 6 information about its supplier price and discounts for, and sales, supply and markets of, its own specific fabrics on the supplier site of the web site by using his/her own supplier password.

Posted on the customer site of the Business' internet web site is the posted supply data 4 and fabric classification data and photograph 2 for each fabric of each Mill and the posted list price 5 for the fabric. This information can be accessed in a conventional manner on the Business' web site, via the internet, but only by authorized Customers of the web site. In this regard, a Customer can only access, via line of communication 7, the customer site of the web site by using his/her own customer password which is assigned by the Business upon application by each Customer and the Customer's agreement to abide by certain obligations, required by the Business. Moreover, a Customer can only access 7 the results of his/her own previous searches and any ongoing searches for fabrics on the web site by using his/her own customer password.

A Customer can search 7 the web site's database by the color, composition and design of the fabrics, contained in the database, as well as by their intended use and application, as well as by their price. The Customer can also view the database photograph of each fabric found by his/her search. Preferably, the Customer can also view one or more, computer generated photos of the fabric, particularly on the same page of the web site. Preferably, the computer-generated photos show the fabric used in some of the applications, of which its Mill originally informed 1 the Business' facility for classifying fabrics.

The Customer can then select 7 one or more fabrics from the database, based on his/her search. From the customer site of the web site, the Customer can either order 7 the fabric(s) or request 7 that a swatch of each fabric be sent to him/her, to see it first-hand before deciding which one(s) to order.

The Business' inventory management automatically transmits, via line of communication 9, any Customer requests, via line of communication 8, for fabric swatches, together with the name and mailing address of the specific Customer, to a fabric swatch supplier. At the same time, the Business' inventory management automatically instructs, via line of communication 10, the Business' Warehouse to cut and pack a small piece of each requested fabric, from a roll of the fabric—preferably from waste pieces of the fabric—in the Warehouse, and then to ship, via line of communication 11, each small piece of fabric to the fabric swatch supplier for the specific Customer. Preferably, the inventory management also then updates automatically its inventory records for the small pieces of fabrics of the Mills, shipped to the swatch supplier.

When the fabric swatch supplier receives the small piece of each requested fabric from the Business' Warehouse, the fabric swatch supplier cuts and packs a swatch of each fabric from the small piece received and then ships it, via line of communication 12, to the specific Customer who requested it.

After the Customer has received any requested swatches of fabric from the swatch supplier, he/she can order 7 specific amounts of one or more fabrics from the customer site of the web site. When ordering 7 fabrics, the Customer automatically agrees with the Business (pursuant to the original application of the Customer to receive a customer password) to pay the Business' posted list price for each fabric amount when the Business' Warehouse ships the fabric to the Customer, less any discounts of the Mills and the Business for the fabric.

A specific Customer's order is transmitted 8 automatically to the inventory management which instructs 10 automatically the Business' Warehouse to cut and pack the specific amount of each ordered fabric, from a roll of the fabric in the Warehouse, and then to ship, via line of communication 13, each fabric amount to the specific Customer.

For each amount of each ordered fabric, shipped to a Customer, the Warehouse informs, via line of communication 14, the Business' financial management and inventory management of: i) the amount shipped, ii) the Business' and the Mill's identification numbers for the ordered fabric, iii) the list price of the fabric and iv) the amount of the fabric that was cut from a roll of the fabric in the Warehouse to provide the amount of fabric which was packed and shipped to the Customer who ordered 7 it. At the same time, the inventory management automatically updates its inventory records for the amount of the fabric that was cut from a roll.

The Business' financial management then sends, via line of communication 15, periodically (e.g., once per month): i) a notice to each Mill, informing the Mill of the Operator's purchase of the amount of each of the Mill's fabrics that the Business' Warehouse has cut, during the period, for packing and shipping to Customers who ordered the fabric and ii) the Operator's credit notice for the Mill's supplier price, less any of its discounts, for the amount of each of the Mill's fabrics, so cut during the period.

As noted above, a Customer automatically agrees, when ordering 7 fabrics, to pay the posted list price, less any discounts, for the amount of each fabric ordered as soon as the Business' Warehouse ships the fabrics to the Customer. Thus, the Business' inventory management requests 16 automatically, from the payment guarantor, a conventional guarantee that the total costs, owed by the Customer for the amounts of fabrics that he/she ordered 7, shall be paid when the Business' Warehouse actually ships the ordered amounts of fabrics to the Customer. When this request 16 of the payment guarantor has been made, and favorably replied to 16, the inventory management instructs 10 the Warehouse to cut, pack and ship the ordered amounts of fabrics to the Customer.

Also, when the Business' Warehouse informs 14 the Business' financial management of a shipment of amounts of ordered fabrics to a Customer, the financial management informs 17 automatically the payment guarantor of the cost of the amounts of fabrics shipped and details of the Customer who ordered 7 the shipped fabrics, so that the payment guarantor can automatically charge such cost to the Customer.

Also, in accordance with this invention, the Business' inventory management periodically advises 5,6 automatically the Mills, via the supplier site of the Business' web site, when necessary, of the need to resupply its fabric(s) to one or more of the Business' Warehouses.

Further, in accordance with this invention, each Mill, when it desires, can enter 6 a higher or lower supplier price for each of its posted fabrics and higher or lower supplier discounts for each fabric on the supplier site of the Business' web site. Such higher and lower supplier prices and discounts can, if desired, also be directed to specific geographical areas and/or markets or market segments of the Mill. Thereafter, the Business' inventory management posts 5 automatically the Business' correspondingly higher or lower list price and/ or discounts for each fabric on the customer site of the Business' internet web site. Preferably, the Business' inventory management posts 5 automatically lower list prices and/or higher discounts on the customer site of the Business' internet web site almost immediately a Mill has lowered 6 its supplier prices and/or raised 6 its discounts but delays for at least 24 hours posting automatically higher list prices and/or lower discounts after a Mill has raised 6 its supplier prices and/or lowered 6 its discounts.

The Business of this invention preferably involves automatic on-line connections for data transmission among: i) its facility for classifying fabrics, ii) its Warehouse, iii) its inventory management system, iv) its internet web site, including both its supplier and customer sites, and v) its financial management. It is especially preferred that these data transmission connections be continuous or at least continuous during normal business hours. It is particularly preferred that the Mills and the payment guarantor also be connected on-line for data transmission to the Business. In this regard, it is preferred that each Mill is connected on-line.

In carrying out the Business of this invention, the selection of the hardware and software, to be used in entering and processing data and requesting action of interlocutors who receive the data, is not critical. In this regard, conventional computer hardware and software systems for managing inventories, accounts and internet web sites can be used. For example, conventional computerized on-line data-entry systems can be used for providing the fabric classification data 2, 3 and the supply data 4 to the Business' data base for use by the Business' inventory management.

This invention is, of course, not limited to the above-described embodiment which can be modified without departing from the scope of the invention or sacrificing all of its advantages. In this regard, the terms in the foregoing description and the following claims, such as “then” and “thereafter”, have been used only as relative terms to describe the relationships of the various steps used in the Business' overall integrated system for carrying out its method of doing the e-commerce business of the invention. For example, other suppliers of fabrics, besides fabric Mills, could consign rolls of fabrics to the Business. Likewise, tangible products other than fabrics, such as furniture, clothing, art work, and jewelry, could be sold by the Business of this invention. Furthermore, fabrics and, of course, other products need not be consigned to the Business in the form of rolls but could be consigned in any other commercially acceptable form, such as square meters. Moreover, after each Mill has: i) verified that the posted supply data 4 and fabric classification data and photograph 2, 4 are accurate on the supplier site of the Business' internet web site for each of its fabrics and ii) entered 6 its supplier price and any discounts for each fabric on the supplier site, the Business could allow the Mill to directly cause such data and photograph, together with the Business' list price for each fabric (when available), to appear on the customer site of the Business' internet web site. In addition, the supplier and customer passwords could be replaced by other conventional security and identification measures, such as electronic signatures and electronic keys.

Exhibit A

Composition

Applications

window treatment—sheer

window treatment—drapery

upholstery or slip cover

bedspread or comforter

Fabric Names

Sheer

batiste

burned-out

lace

leno/marquisette

voile

percale/muslin

organza

embroidery

Drapery/Upholstery

bark cloth

bouclé

brocade

brocatelle

canvas/duck

changeant

chenille

chintz

corduroy

crash

crepe

cretonne

damask/fortuny

denim

embroidery

epinglé

felt

flannel

fleece

fur-like

interlinings

jacquard

leather-like

linen

linen-like

matelassé

mohair

moiré

needlepoint

paisley

plaid

poplin

repp/ottoman

sateen

satin

satin/shantung

silk

silk-like

strié/jaspé

suede-like

tapestry/gobelin

toile

tweed

velvet

Base Materials (i.e., the composition)

Any

Acrylic

Cotton

Linen

Polyester

Silk

Viscose/Rayon

Wool

Design Application (i.e., the method used to get a design into or on to a fabric)

dyed

knitted

printed

stitched

woven

Exhibit B

Design

Descriptors

Era

Elizabethan

Neo-classic

Victorian

Early 20th century

Post-war

Current

Geographic Origin

Africa

East Asia

Europe

Britain

France

Italy

Scandinavia

India

Middle East

North America

South America

Theme

Gothic

Baroque

Rococo

Chinoiserie

Colonial

Art Nouveau

Modern

Country

Ethnic

Safari

Dimensions

Pattern Type

animal

figure

floral

geometric

novelty

ornament

scenic

Secondary Color Contrast

none

tonal

neutral

colorful

rich

vivid

brash

clashing

Pattern Size (i.e. color distribution)

plain

flecks

highlights

bold highlights

patches

large areas

Styling (i.e., formality)

stately

formal

refined

whimsical

informal

casual

shabby

Repeat Scale

micro—for repeats up to 4 cm

mini—for repeats between 4 cm and 10 cm

small—for repeats between 10 cm and 20 cm

medium—for repeats between 20 cm and 35 cm

large—for repeats between 35 cm and 50 cm

over scale—for repeats over 50 cm

Simplicity

austere

simple

lively

ornate

busy

vibrant

opulent

hectic

1. A method of doing an e-commerce business which enables customers to purchase products, such as fabrics, directly from their suppliers, such as their manufacturers, through an internet web site containing information about the products, comprising:
establishing a database with data entries for each of the products, consigned by its supplier to the business; the database comprising data for at least one of the price, composition, color, design and supply of each product; and data of the database being accessible to the customers, suppliers and the business via the web site.

2. The method of claim 1 wherein data of the database for the supply of each product of a supplier are continuously updated as the supply increases or decreases and are accessible via the web site to the supplier but not to customers or other suppliers.

3. The method of claim 1 wherein the data of the database for each product includes both a price to the business, set by the product's supplier, and a price to the customers, set by the business.

4. The method of claim 3, wherein the price, discounts and/or promotions, set by the supplier for each of its products, is accessible via the web site to the supplier but not to customers or other suppliers.

5. The method of claim of 3 wherein the data of the database for the price to the customers of each product also includes discounts and/or promotions to the business, set by the product's supplier, and discounts and/or promotions to the customers, set by the business.

6. The method of claim 5 wherein each supplier can change, in the database, the supplier's set discounts and/or promotions to the business for each of the supplier's products, which results automatically in an eventual change in the business' set discounts and/or promotions to the customers for the product.

7. The method of claim 6 wherein the business can also change, in the database, the business' set discounts and/or promotions to the customers for the supplier's product.

8. The method of claim 3 or 5 wherein each supplier can change, in the database, the supplier's set price to the business for each of the supplier's products, which results automatically in an eventual change in the business' set price to the customers for the product.

9. The method of claim 8 wherein each supplier can change, in the database, the supplier's set discounts and/or promotions to the business for each of the supplier's products, which results automatically in an eventual change in the business' set discounts and/or promotions to the customers for the product.

10. The method of claim 9 wherein the business can also change, in the database, the business' set discounts and/or promotions to the customers for the supplier's product.

11. The method of claim 10, wherein the price, discounts and/or promotions, set by the supplier for each of its products, is accessible via the web site to the supplier but not to customers or other suppliers.

12. The method of claims 11 wherein data of the database for the supply of each product of a supplier are continuously updated as the supply increases or decreases and are accessible via the web site to the supplier but not to customers or other suppliers.

13. The method of claim 12 wherein the business automatically pays each supplier for each sale of each product of the supplier to a customer after the customer orders the product and is automatically charged for the sale of the product.

14. The method of claim 13 wherein the product is a fabric.

15. A method of doing an e-commerce business which enables customers to purchase products, such as fabrics, directly from their suppliers, such as their manufacturers, through an internet web site containing information about the products, comprising:
establishing a database with data entries for each of the products, consigned by its supplier to the business; and
establishing a customers site on the web site that is accessible to the customers and a suppliers site on the web site that is accessible to the suppliers;
wherein data of the database that are accessible to the customers on the customers site are different from data of the database that are accessible to the suppliers on the suppliers site.

16. The method of claim 15 wherein data of the database for the supply of each product of each supplier are continuously updated as the supply increases or decreases and are accessible, via the web site, to the supplier on the suppliers site but not to customers on the customers site.

17. The method of claim 16 wherein only the supplier of a fabric can access, on the suppliers site, data of the database on the sales and supply of the fabric.

18. The method of claim 16 wherein each supplier can access, on the suppliers site, data of the database on sales trends of products of other suppliers.

19. The method of claim 15 wherein data of the database are continuously updated and the different data of the database, accessible via the customers and suppliers sites, are simultaneously and continuously updated.

20. The method of claim 15 or 19 wherein the data of the database for the price of each product includes both the price to the business, set by the product's supplier, and the price to consumers, set by the business; wherein each supplier can change, in the database, the supplier's set price for each of the supplier's products, which results automatically in an eventual change in the business' set price to consumers for the product; and wherein the supplier's set price for each of the supplier's products is accessible to the supplier on the suppliers site but is not accessible to customers on the customers site.

21. The method of claim of 20 wherein the data of the database for the price to the customers of each product also include discounts and/or promotions to the business, set by the product's supplier, and/or discounts and/or promotions to the customers, set by the business.

22. The method of claim 21 wherein data of the database for the supply of each product of each supplier are continuously updated as the supply increases or decreases and are accessible, via the web site, to the supplier on the suppliers site but not to customers on the customers site.

23. The method of claim 22 wherein only the supplier of a fabric can access, on the suppliers site, data of the database on the sales and supply of the fabric.

24. The method of claim 23 wherein each supplier can access, on the suppliers site, data of the database on sales trends of products of other suppliers.

25. The method of claim 24 wherein the product is a fabric

26. The method of claim 24 wherein the business automatically pays each supplier for each sale of each product of the supplier to a customer after the customer orders the product and is automatically charged for the sale of the product.

27. The method of claim 26 wherein the product is a fabric.

28. The method of claim 1 or 15 wherein the business automatically pays each supplier for each sale of each product of the supplier to a customer after the customer orders the product and is automatically charged for the sale of the product.
